(19) United States
(12) Patent Application Publication
(10) Pub. No.: US 2010/0112411 A1
(43) Pub. Date: May 6, 2010

(54) Fuel cell system

(75) Inventors: Eon Soo Lee, Seoul (KR); Jae Hyuk Jang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/320,993

(22) Filed: Feb. 10, 2009

(30) Foreign Application Priority Data
Oct. 30, 2008 (KR) 10-2008-0107116

(51) Int. Cl. H01M 2/02; H01M 8/04

(52) U.S. Cl. 429/34

(57) ABSTRACT

Disclosed is a fuel cell system, including a hydrogen storage container including a tank case having an accommodation space and a hydrogen storage tank provided in the tank case, a fuel cell which receives desorbed hydrogen from the hydrogen storage tank to generate electricity, and a connection duct for supplying high-temperature unreacted hydrogen from the fuel cell to the tank case. In the fuel cell system, heat of unreacted hydrogen discharged from the fuel cell can be supplied to the hydrogen storage tank through convective heat transfer, thus obviating a need for an additional heater for heating the hydrogen storage tank and increasing energy usage efficiency.

### CROSS REFERENCE TO RELATED APPLICATION

This application claims the benefit of Korean Patent Application No. 10-2008-0107116, filed Oct. 30, 2008, entitled “Fuel cell system”, which is hereby incorporated by reference in its entirety into this application.

### BACKGROUND OF THE INVENTION

1. Field of the Invention

The present invention relates to a fuel cell system, and more particularly, to a fuel cell system which can stably supply heat to a hydrogen storage tank through recirculation of heat generated from a fuel cell.

2. Description of the Related Art

Recently, the use of portable small-sized electronic devices, including mobile phones, PDAs, digital cameras, notebook PCs, etc., is increasing. In particular, with the start of digital multimedia broadcasting (DMB) for mobile phones, a small-sized mobile terminal is required to be improved in power capacity.

A lithium ion secondary battery available at present has a capacity enabling about 2 hours of DMB viewing, and attempts to improve performance thereof have been made. However, as a more fundamental solution, there has been a growing expectation for a fuel cell reduced in size and capable of providing high-capacity power.

A conventional power generation technique for directly converting chemical energy of fuel (hydrogen, LNG, LPG, methanol, etc.) and air into electricity and heat through an electrochemical reaction includes fuel combustion, steam generation, turbine operation and generator operation, whereas a fuel cell does not need a combustion procedure or an operation apparatus and has high efficiency without causing environmental problems, and is thus regarded as a novel type of power generation technique.

The fuel cell may be divided into, depending on the type of electrolyte used therefor, an alkaline fuel cell (AFC), a phosphoric acid fuel cell (PAFC), a molten carbonate fuel cell (MCFC), and a polymer electrolyte membrane fuel cell (PEMFC). Among them, the PEMFC may be subdivided into a photon exchange membrane fuel cell directly using hydrogen gas as a fuel and a direct methanol fuel cell directly using liquid methanol as a fuel.

The PEMFC may be operated at lower temperatures and may have higher output density, compared to the other fuel cells, thus making it possible to manufacture it to be small and light. For this reason, the PEMFC is very suitable for use in transportable on-site power sources of automobiles and so on, distributed on-site power sources of houses or public institutions, and small on-site power sources for electronic devices, and thorough research and development thereof is conducted.

As such, in order to commercialize the PEMFC, stable production and supply of hydrogen should be a first consideration. To this end, a metal hydride-based fuel cell for supplying hydrogen gas to the fuel cell in a state in which a large amount of hydrogen is stored in a storage tank using metal hydride is receiving attention. However, because metal hydride should absorb heat to discharge hydrogen gas, a hydrogen storage tank should be designed to stably absorb heat.

FIGS. 1 and 2 show fuel cell systems including means for supplying heat to a hydrogen storage tank according to conventional techniques.

As shown in FIG. 1, a fuel cell system 10 according to a first conventional technique includes an additional heater 40. The heater 40 functions to supply heat to a hydrogen storage tank 20 so that hydrogen stored in the hydrogen storage tank 20 is stably supplied to a fuel cell 30.

As shown in FIG. 2, a fuel cell system 10′ according to a second conventional technique includes a heater 40 such as a burner, as in the first conventional technique. As such, the heater 40 may be operated using unreacted hydrogen of the fuel cell 30 supplied through a connection duct 50.

However, these conventional techniques are problematic because the additional heater 40 must essentially be provided, the total size of the apparatus is increased and thus the structure thereof becomes complicated. As well, the heater 40 may undesirably increase danger of the apparatus when used in conjunction with the hydrogen storage tank 20.

### SUMMARY OF THE INVENTION

Accordingly, the present invention has been made keeping in mind the problems encountered in the related art and the present invention provides a fuel cell system, which is capable of stably supplying heat to a hydrogen storage tank through recirculation of heat generated from a fuel cell without the use of an additional heater.

In addition, the present invention provides a fuel cell system, in which heat generated from a fuel cell can be supplied to a hydrogen storage tank through conduction and convection using a simple structure.

According to a preferred embodiment of the present invention, a fuel cell system includes a hydrogen storage container including a tank case having an accommodation space and a hydrogen storage tank provided in the tank case, a fuel cell which receives desorbed hydrogen from the hydrogen storage tank to generate electricity, and a connection duct for supplying high-temperature unreacted hydrogen from the fuel cell to the tank case.

The hydrogen storage container may have a hexahedral structure.

The hydrogen storage tank may have a channel which is formed on and along an outer wall thereof such that the channel protrudes into the accommodation space of the tank case so as to control the flow of the unreacted hydrogen.

The fuel cell may be attached to the hydrogen storage container using a thermal adhesive layer.

Alternatively, a plurality of fuel cells may be attached to the hydrogen storage container.

The fuel cell system may further include a pressure regulator for regulating pressure of the desorbed hydrogen which is to be supplied from the hydrogen storage tank to the fuel cell.

The connection duct may be provided with a flow rate control valve for controlling the flow rate of the unreacted hydrogen to be supplied to the tank case.

The fuel cell system may further include a recovery duct for recovering the unreacted hydrogen from the fuel cell so that the hydrogen is supplied again to the fuel cell.

The hydrogen storage container may include an air circulation fan to transfer air of the atmosphere or heat generated from the fuel cell to the hydrogen storage container.

The hydrogen storage container may include an assistant heater to supply heat to the hydrogen storage tank.

The features and advantages of the present invention will be more clearly understood from the following detailed description taken in conjunction with the accompanying drawings.

Further, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

### BRIEF DESCRIPTION OF THE DRAWINGS

FIG. 1 is a schematic view showing a fuel cell system according to a first conventional technique;

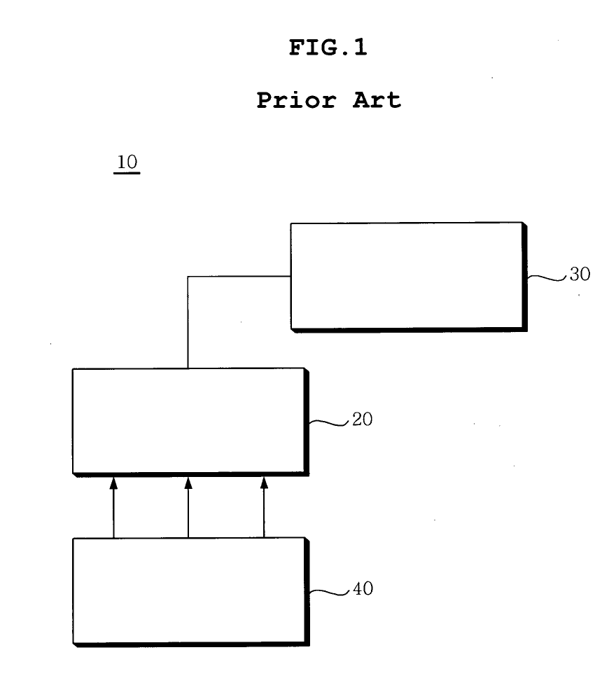

FIG. 2 is a schematic view showing a fuel cell system according to a second conventional technique;

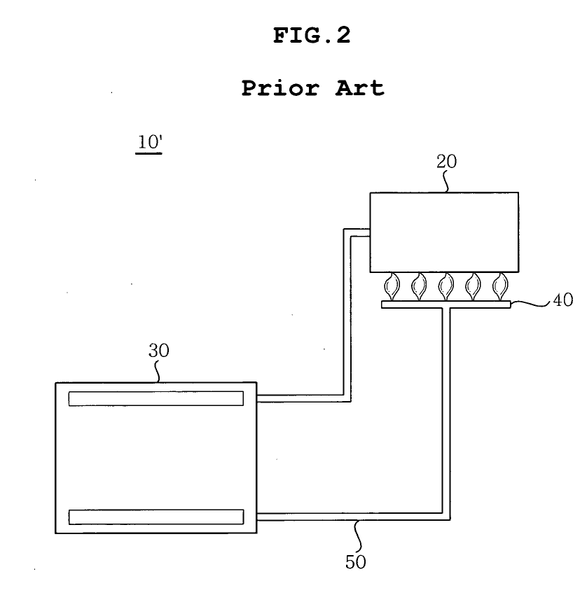

FIG. 3 is a schematic perspective view showing a fuel cell system according to a preferred embodiment of the present invention;

FIG. 4 is a schematic perspective view showing a fuel cell system having a plurality of fuel cells according to another preferred embodiment of the present invention;

FIGS. 5A to 5C are views showing the channel shape in the tank case according to the preferred embodiment of the present invention; and

FIG. 6 is a view showing the operation principle of the fuel cell according to the preferred embodiment of the present invention.

### DESCRIPTION OF THE PREFERRED EMBODIMENTS

The features and advantages of the present invention will be more clearly understood from the following detailed description and preferred embodiments taken in conjunction with the accompanying drawings. Throughout the drawings, the same reference numerals refer to the same or similar elements, and redundant descriptions are omitted. In order to make the characteristics of the invention clear and for the convenience of description, a detailed description pertaining to the other known techniques may be omitted.

Hereinafter, a detailed description will be given of the present invention, with reference to the accompanying drawings.

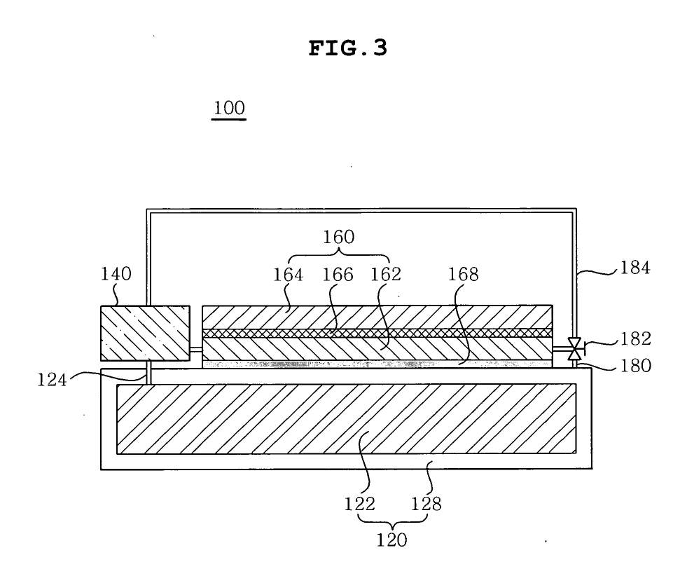

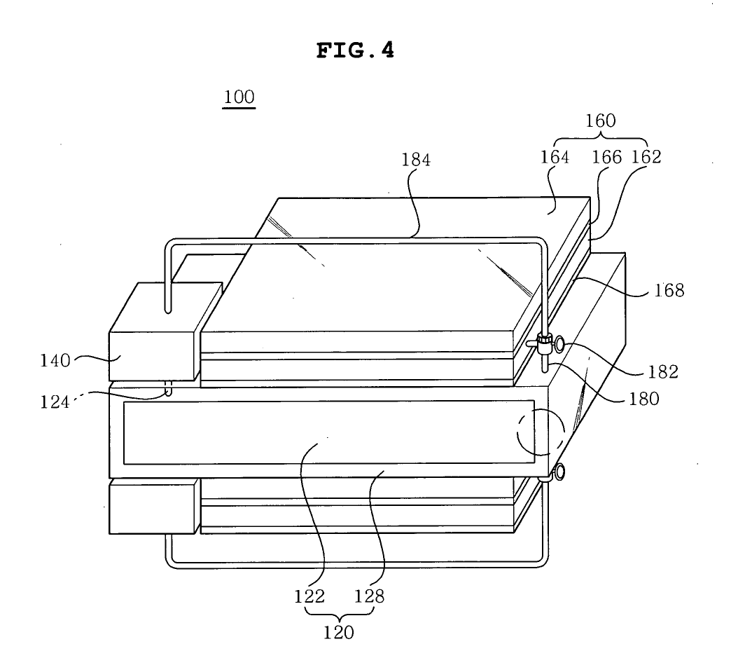

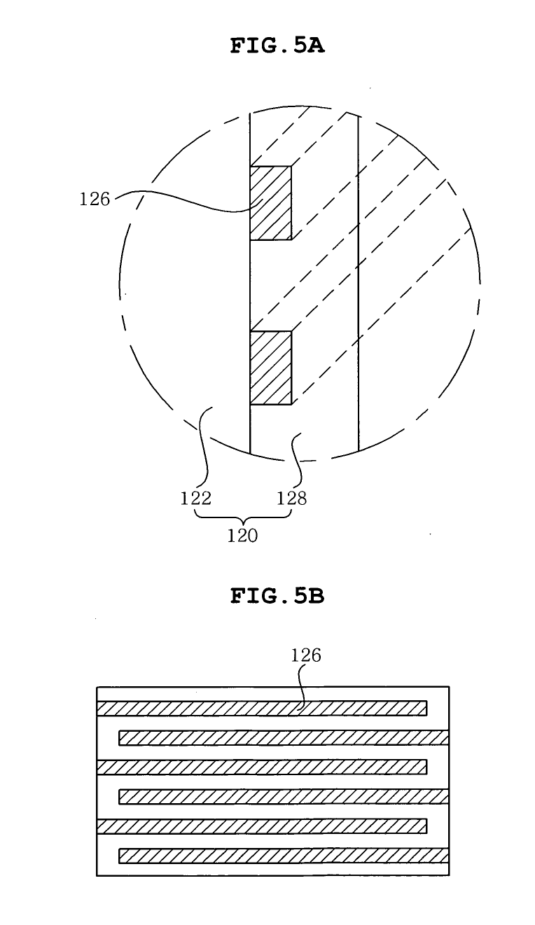

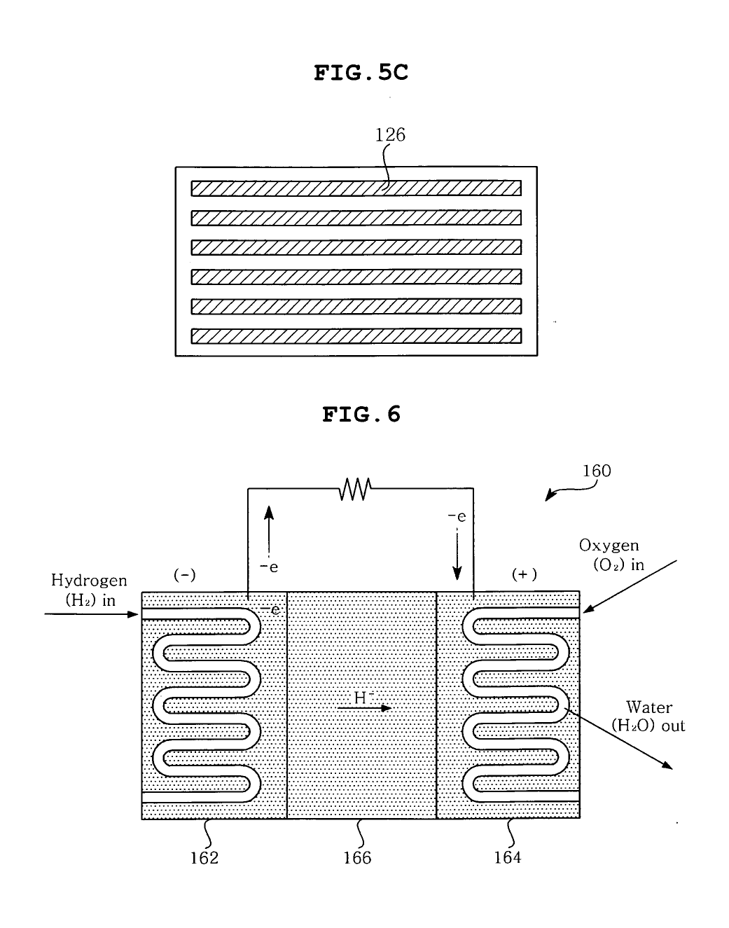

FIG. 3 is a schematic perspective view showing a fuel cell system according to a preferred embodiment of the present invention, FIG. 4 is a schematic perspective view showing a fuel cell system having a plurality of fuel cells according to another preferred embodiment of the present invention, FIGS. 5A to 5C are views showing the channel shape in the tank case according to the preferred embodiment of the present invention, and FIG. 6 is a view showing the operational principle of the fuel cell according to the preferred embodiment of the present invention.

With reference to FIGS. 3 and 4, the fuel cell system 100 according to the preferred embodiments of the present invention is described below.

As shown in FIGS. 3 and 4, the fuel cell system 100 includes a hydrogen storage container, 120, at least one fuel cell 160, and a connection duct 180 for supplying unreacted hydrogen of the fuel cell 160 to the hydrogen storage container 120.

The hydrogen storage container 120 includes a tank case 128 having a predetermined accommodation space and a hydrogen storage tank 122 provided in the tank case 128. The shape of the hydrogen storage container 120 is not limited, but may have a planar structure (e.g., a hexahedral structure) so that the fuel cell 160 is easily attached to the hydrogen storage container 120, which will be described later.

The hydrogen storage tank 122 functions to store metal hydride so that hydrogen is desorbed from the stored metal hydride and is supplied-to the fuel cell 160, and includes a predetermined inner space for storing metal hydride therein.

The hydrogen storage tank 122 has channels 126 which are formed on and along the outer wall thereof such that they protrude into the accommodation space of the tank case 128 so as to control the flow of unreacted hydrogen. The channel 126 is described later with reference to FIG. 5.

The hydrogen storage tank 122 may be connected to the fuel cell 160 via a supply duct 124 such that desorbed hydrogen is supplied to the fuel cell 160. In order to regulate the pressure of hydrogen to be supplied to the fuel cell 160, the supply duct 124 may be provided with a pressure regulator.

The accommodation space of the tank case 128 may again receive high-temperature unreacted hydrogen which does not participate in the chemical reaction, from the hydrogen supplied to the fuel cell 160 from the hydrogen storage tank 122, thereby feeding heat of the high-temperature unreacted hydrogen to the hydrogen storage tank 122.

The fuel cell 160 typically has a fuel usage efficiency of about 80%, and therefore, about 20% of the hydrogen supplied to the fuel cell 160 does not participate in the chemical reaction of the fuel cell 160. Although such high-temperature unreacted hydrogen is conventionally emitted to the atmosphere, in the fuel cell system according to the present invention, the unreacted hydrogen is not emitted but is re-circulated, thus reusing heat energy of the unreacted hydrogen. Specifically, the unreacted hydrogen in a high-temperature state due to heat generated by the chemical reaction of the fuel cell 160 is supplied to the tank case 128 and thus circulated, whereby heat can be supplied to the hydrogen storage tank 122 through convective heat transfer.

The tank case 128 has a hydrogen inlet port connected to the connection duct 180 to enable the inflow of the unreacted hydrogen and a hydrogen outlet port for discharging the unreacted hydrogen after it has circulated the tank case 128.

Also, with the goal of lengthening the contact time between the high-temperature unreacted hydrogen in the tank case 128 and the hydrogen storage tank 122 so as to increase the convective heat transfer efficiency, the channels 126 are formed on and along the outer wall of the hydrogen storage tank 122 such that they protrude from the inner wall of the tank case 128. The channel 126 is described later with reference to FIG. 5.

Further, a sealing member (not shown) may be provided between the hydrogen storage tank 122 and the tank case 128 to prevent hydrogen desorbed from metal hydride from being discharged to the outside.

The fuel cell 160, which receives desorbed hydrogen from the hydrogen storage tank 122 to generate electricity, is connected to the hydrogen storage tank 122 via the supply duct 124.

The fuel cell 160 may have a structure of membrane-electrode assembly in which an electrolytic membrane 166 is disposed between an anode 164 and a cathode 162 formed at both sides thereof. The fuel cell 160 may have a single membrane-electrode assembly or a membrane-electrode assembly stack. For convenience, the fuel cell 160 having the single membrane-electrode assembly is illustrated in FIGS. 3 and 4. The operational principle of the fuel cell 160 is described later with reference to FIG. 6.

Also, the fuel cell 160 may be attached to the hydrogen storage container 120 by means of a thermal adhesive layer 168 in order to supply heat generated due to the chemical reaction to the hydrogen storage tank 122 through conductive heat transfer. The case where the hydrogen storage container 120 has a planar structure (e.g., hexahedral shape) facilitates the attachment of the fuel cell 160.

As such, the number of fuel cells 160 to be attached to the hydrogen storage container 120 may be one or more. In FIG. 3, the structure in which the fuel cell 160 is attached to the upper surface of the hydrogen storage container 120 is illustrated, and in FIG. 4, the structure in which two fuel cells 160 are respectively attached to the upper and lower surfaces of the hydrogen storage container 120 is illustrated. If a sufficient amount of hydrogen may be supplied to a plurality of fuel cells 160 by a single hydrogen storage tank 122, the number of fuel cells 160 to be attached in a state of being connected to the hydrogen storage container 120 may be further increased. For example, as shown in FIGS. 3 and 4, when the hydrogen storage container 120 has a hexahedral structure, it is possible to attach the fuel cells 160 to respective surfaces thereof.

The connection duct 180 is used to supply the high-temperature unreacted hydrogen from the fuel cell 160 to the tank case 128, and one end thereof is connected to the hydrogen outlet port of the fuel cell 160 and the other end thereof is connected to the hydrogen inlet port of the tank case.

The connection duct 180 may be provided with a flow rate control valve 182 for controlling the flow rate of the unreacted hydrogen discharged from the fuel cell 160.

Also, a recovery duct 184 may be provided so that part of the unreacted hydrogen discharged from the fuel cell 160 is supplied again to the fuel cell 160. One end of the recovery duct 184 is connected to the hydrogen outlet port of the fuel cell 160 to receive the unreacted hydrogen discharged from the fuel cell, and the other end thereof is connected to the hydrogen inlet port of the fuel cell 160 so that the unreacted hydrogen gas received therein is supplied again to the fuel cell 160. The recovery duct 184 may be connected to the pressure regulator 140 to supply hydrogen from the hydrogen storage tank 122 to the fuel cell 160 in consideration of the flow rate of the hydrogen.

Also, an air circulation fan (not shown) may be provided to transfer air of the atmosphere and/or heat discharged upon operation of the fuel cell 160 to the hydrogen storage tank 122.

Moreover, in the case where high power is required, a large amount of hydrogen should be supplied to the fuel cell 160 and also hydrogen should be stably and continuously supplied to the fuel cell 160. To this end, an assistant heater (not shown) may be provided to adequately supply heat to the hydrogen storage tank 122.

With reference to FIGS. 5A to 5C, the structure and shape of the channel 126 in the tank case according to the preferred embodiment of the present invention are described below.

As shown in FIG. 5A, the channels 126 are formed on and along the outer wall of the hydrogen storage tank 122 such that they protrude into the tank case 128.

The channels 126 may have various channel structures to control the flow of the high-temperature unreacted hydrogen so as to increase convective heat transfer efficiency. For example, as shown in FIG. 5B, the channels may be provided in a zigzag form, or as shown in FIG. 5C, a plurality of channels may be provided parallel to each other. The shapes of the channels of FIGS. 5B and 5C are merely illustrative, and various shapes including an oblique line and so on may be applied.

With reference to FIG. 6, the operational principle of the fuel cell 160 according to the preferred embodiment of the present invention is briefly described below.

At the anode 162, hydrogen (H₂) is decomposed into protons (H⁺) and electrons (e⁻). The protons are transported to the cathode 164 via the electrolytic membrane 166, while the electrons generate current through the external circuit. At the cathode 164, the protons and the electrons are combined with oxygen in the air, thus producing water. The chemical reaction of the fuel cell 160 is represented by Formula 1 below.

Anode 162: H₂→2H⁺+2e⁻ Formula 1

Cathode 164: ½O₂+2H⁺+2e⁻→H₂O

Total reaction: H₂+½O₂→H₂O

Specifically, the electrons separated at the anode 162 generate current through the external circuit, thereby realizing cell functionality.

The fuel cell system 100 thus constructed is operated as follows.

The desorbed hydrogen is supplied from the hydrogen storage tank 122 to the fuel cell 160 in a state in which the pressure thereof is regulated using the pressure regulator 140, and the fuel cell 160 generates electricity through the chemical reaction. As such, heat generated due to the chemical reaction of the fuel cell 160 is transferred to the hydrogen storage container 120 via the thermal adhesive layer 168 and thus supplied to the hydrogen storage tank 122. The high-temperature unreacted hydrogen discharged from the fuel cell 160 is supplied to the tank case 128 via the connection duct 180, thus feeding the heat to the hydrogen storage tank 122 through convective heat transfer. Part of the unreacted hydrogen is supplied again to the fuel cell 160 via the recovery duct 184 to thus be reused.

In this way, because the heat discharged upon operation of the fuel cell 160 and/or the heat of the high-temperature unreacted hydrogen may be supplied again to the hydrogen storage tank 122 and thus may be reused, the desorption of hydrogen may be easily performed even without the use of the additional heater, resulting in a fuel cell system 100 having net increased heat efficiency.

As described hereinbefore, the present invention provides a fuel cell system. In the fuel cell system according to the present invention, the fuel cell can be attached to the hydrogen storage tank by means of a thermal adhesive layer, thus supplying heat generated from the fuel cell to the hydrogen storage tank through conductive heat transfer, thereby obviating a need for an additional heater for heating the hydrogen storage tank.

Also, in the fuel cell system according to the present invention, high-temperature unreacted hydrogen discharged from the fuel cell can be supplied to the tank case, thus supplying heat of the high-temperature unreacted hydrogen to the hydrogen storage tank through convective heat transfer, thereby obviating a need for the additional heater for heating the hydrogen storage tank.

Also, in the fuel cell system according to the present invention, the high-temperature unreacted hydrogen discharged from the fuel cell is supplied again to the fuel cell, thereby increasing hydrogen usage efficiency.

Also, the atmosphere and/or the heat discharged upon operation of the fuel cell can be transferred toward the hydrogen storage tank using an air circulation fan, thereby supplying heat to the hydrogen storage tank.

Although the preferred embodiments of the present invention regarding the fuel cell system have been disclosed for illustrative purposes, those skilled in the art will appreciate that various modifications, additions and substitutions are possible within the technical scope of the invention.

What is claimed is:

1. A fuel cell system, comprising:
a hydrogen storage container including a tank case having an accommodation space and a hydrogen storage tank provided in the tank case;
a fuel cell which receives desorbed hydrogen from the hydrogen storage tank to generate electricity; and
a connection duct for supplying high-temperature unreacted hydrogen from the fuel cell to the tank case.

2. The fuel cell system as set forth in claim 1, wherein the hydrogen storage container has a hexahedral structure.

3. The fuel cell system as set forth in claim 1, wherein the hydrogen storage tank has a channel which is formed on and along an outer wall thereof such that the channel protrudes into the accommodation space of the tank case so as to control a flow of the unreacted hydrogen.

4. The fuel cell system as set forth in claim 1, wherein the fuel cell is attached to the hydrogen storage container using a thermal adhesive layer.

5. The fuel cell system as set forth in claim 4, wherein a plurality of fuel cells is attached to the hydrogen storage container.

6. The fuel cell system as set forth in claim 1, further comprising a pressure regulator for regulating pressure of the desorbed hydrogen which is to be supplied from the hydrogen storage tank to the fuel cell.

7. The fuel cell system as set forth in claim 1, wherein the connection duct is provided with a flow rate control valve for controlling a flow rate of the unreacted hydrogen to be supplied to the tank case.

8. The fuel cell system as set forth in claim 1, further comprising a recovery duct for recovering the unreacted hydrogen from the fuel cell so that the hydrogen is supplied again to the fuel cell.

9. The fuel cell system as set forth in claim 1, wherein the hydrogen storage container includes an air circulation fan to transfer air of an atmosphere or heat generated from the fuel cell to the hydrogen storage container.

10. The fuel cell system as set forth in claim 1, wherein the hydrogen storage container includes an assistant heater to supply heat to the hydrogen storage tank.
